(19) United States
(12) Patent Application Publication
(10) Pub. No.: US 2026/0150839 A1
(43) Pub. Date: Jun. 4, 2026

(54) CERVINOMYCIN MIXTURES AND USES THEREOF

(71) Applicant: Valent BioSciences LLC, Libertyville, IL (US)

(72) Inventor: Julia Crane, Libertyville, IL (US)

(21) Appl. No.: 19/460,585

(22) Filed: Jan. 27, 2026

(51) Int. Cl. A01N 43/42; A01P 3/00

(52) U.S. Cl. CPC A01N 43/42; A01P 3/00

(57) ABSTRACT

The present invention is directed to pesticidal mixtures comprising one or more cervinomycins and at least one additional compound listed below in paragraph [0011]. Further, the present invention is directed to methods of controlling a pest comprising applying an effective amount of a mixture of the present invention to the pest or an area in need of pest control.

### FIELD OF THE INVENTION

The present invention is directed to pesticidal mixtures comprising one or more cervinomycins and at least one additional compound listed below in paragraph [0011]. Further, the present invention is directed to methods of controlling a pest comprising applying an effective amount of a mixture of the present invention to the pest or an area in need of pest control.

### BACKGROUND OF THE INVENTION

Plant pathogens are a major cause of severe economic loss in the agricultural and horticultural industries. Plant pathogens account for the loss of millions of pounds of crops each year. Two particularly troublesome types of plant pathogens are fungi and oomycetes.

Oomycetes are plant pathogens that like fungi produce filamentous threads and obtain nutrients via absorption. Phytophthora capsici, P. infestans, Pythium ultimum and downy mildew pathogens are economically important groups of oomycete plant pathogens. P. infestans is the cause of late blight on tomatoes and potatoes and was the disease which precipitated the Irish potato famine. More recently, potato yield losses from this disease can reach as high as $6.7 billion annually. See, Nowicki M. et al., Potato and Tomato Late Blight Caused by Phytophthora infestans: An Overview of Pathology and Resistance Breeding, PLANT DIS. 2012 January, 96(1), 4-17. Downy mildew is a disease caused by several host-specialized oomycete species, including Pseudoperonospora cubensis (cucurbits), Bremia lactucae (leafy greens), and Plasmopara viticola (grapes). Like P. infestans, these downy mildew pathogens can quickly spread through agricultural fields and lead to devastating yield losses on crops which otherwise would comprise $7.5 billion annually in the United States alone. See, Crandall S. G., Advances in Diagnostics of Downy Mildews: Lessons Learned from Other Oomycetes and Future Challenges, PLANT DIS. 2018 February, 102(2), 265-275.

Fungal plant pathogens include over 20,000 species of fungi that are mostly from the phyla Ascomycota and Basidiomycota. Zymoseptoria tritici, known as Septoria leaf blotch, infects wheat plants. Septoria leaf blotch is a threat to wheat production worldwide. This infection is estimated to cost almost $300 million dollars per year in the United States and over $400 million dollars per year in Europe in lost crops. Efforts have been made to control Septoria leaf blotch but the disease has developed resistance to many fungicides.

Many fungicides have been developed to control plant diseases such as those described above. Despite this many plant pathogens have developed resistance to these fungicides. Finally, the number of products registered for use against oomycete pathogens is much more limited, due in part to the voracious nature of these pathogens.

Thus, there is a need in the art for fungicide mixtures that controls oomycetes and a variety of fungal plant pathogens.

### SUMMARY OF THE INVENTION

In one aspect, the present invention is directed to pesticidal mixtures comprising one or more cervinomycins and at least one additional compound listed below in paragraph [0011].

In another aspect, the present invention is directed to methods of controlling a pest comprising applying an effective amount of a mixture of the present invention to the pest or an area in need of pest control.

### DETAILED DESCRIPTION OF THE INVENTION

Applicant has unexpectedly discovered that cervinomycin mixtures are capable of controlling unwanted oomycete growth. Applicant has further unexpectedly discovered that particular cervinomycins mixtures are capable of controlling fungi.

In one embodiment, the present invention is directed to pesticidal mixtures comprising one or more cervinomycins and at least one additional compound listed below in paragraph [0011].

Additional compounds suitable for use in the present invention include, but are not limited to:
methyl benzimidazole carbamates (FRAC Group 1) including benomyl, carbendazim, fuberidazole, thiabendazole, thiophanate and thiophanate-methyl;
dicarboxamides (FRAC Group 2) including chlozolinate, dimethachlone, vinclozolin, procymidone and iprodione;
demethylation inhibitors (FRAC Group 3) including triforine, pyrifenox, pyrisoxazole, fenarimol, nuarimol, imazalil, oxpoconazole, pefurazoate, prochloraz, triflumizole, azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole and prothioconazole;
phenylamids (FRAC Group 4) including metalaxyl, metalaxyl-M, benalaxyl, benalaxyl-M, oxadixyl, furalaxyl, oxadixyl and ofurace;
amines (FRAC Group 5) including aldimorph, dodemorph, fenpropimorph, tridemorph, fenpropidin, piperalin and spiroxamine;
phosphoro-thiolates (FRAC Group 6) including edifenphos, iprobenfos and pyrazophos; dithiolanes (FRAC Group 6) including isoprothiolane;
succinate dehydrogenase inhibitors (FRAC Group 7) including benodanil, flutolanil, isofetamid, mepronil, fluopyram, cyclobutrifluram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pydiflumetofen, boscalid and pyraziflumid; hydroxy-(2-amino-)pyrimidines (FRAC Group 8) including bupirimate, dimethirimol, and ethirimol;
anilino-pyrimidines (FRAC Group 9) including cyprodinil, pyrimenthanil and mepaniyrim; n-phenyl carbamates (FRAC Group 10) including diethofencarb;
quinone outside inhibitors (FRAC Groups 11 and 11A) including azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone, pyribencarb and metyltetraprole;
phenylpyrroles (FRAC Group 12) including fludioxonil and fenpiclonil;
azanaphthalenes (FRAC Group 13) including quinoxyfen and proquinazid;
aromatic hydrocarbon fungicides (FRAC Group 14) including biphenyl, chloroneb, dicloran, quintozene, tecnazene and tolclofos-methyl;
isobenzo-furanones (FRAC Group 16.1) including fthalide;
pyrrolo-quinolinones (FRAC Group 16.1) including pyroquilon; triazolobenzo-thiazoles (FRAC Group 16.1) including tricylazole;
cyclopropane-carboxmides (FRAC Group 16.2) including carpropamid, dicocymet and fenoxanil;
trifluoroethyl-carbamates (FRAC Group 16.3) including tolprocarb;
ketoreductase inhibitors (FRAC Group 17) including fenhexamid and fenpyrazamine; thiocarbamates (FRAC Group 18) including pyributicarb;
allylamines (FRAC Group 18) including naftifine and terbinafine;
polyoxins (FRAC Group 19) including polyoxin;
phenylureas (FRAC Group 20) including pencycuron;
quinone inside inhibitors (FRAC Group 21) including cyazofamid, amisulbrom, florylpicoxamid and fenpicoxamid;
benzamides and thiazole carboxamides (FRAC Group 22) including zoxamide and ethaboxam; enopyranuronic acid antibiotics (FRAC Group 23) including blasticidin-S;
hexopyranosyl antibiotics (FRAC Group 24) including kasugamycin;
glucopyranosyl antibiotics (FRAC Group 25) including streptomycin;
glucopyranosyl antibiotics (FRAC Group 26) including validamycin;
phosphonates (FRAC Group P 07) including fosetyl-al and phosphorous acid and salts;
isothiazoles (FRAC Group 08) including dichlobentiazox;
cyanoacetamide-oximes (FRAC Group 27) including cymoxanil;
phenylacetamides (FRAC Group U 06) including cyflufenamid;
tetrazolyloxime (FRAC Group U 17) including picarbutrazox;
carbamates (FRAC Group 28) including iodocarb, propamocarb and prothiocarb;
2,6-dinitro-anilines (FRAC Group 29) including fluazinam, binapacryl, meptyldinocap, dinocap and ferimzone;
organo tin compounds (FRAC Group 30) including fentin acetate, fentin chloride and fentin hydroxide;
carboxylic acids (FRAC Group 31) including oxolinic acid;
heteroaromatics (FRAC Group 32) including hymexazole and octhilinone;
thiphene-carboxamides (FRAC Group 38) including silthiofam;
pyrimidinamines (FRAC Group 39) including diflumetorim;
pyrazole-5-carboxamides (FRAC Group 39) including tolfenpyrad;
quinazolines (FRAC Group 39) including fenazaquin;
carboxylic acid amides (FRAC Group 40) including dimethomorph, benthiavalicarb, mandipropamid, iprovalicarb, flumorph, pyrimorph, valifernacarb, valifenalate;
tetracycline antibiotics (FRAC Group 41) including oxytetracycline;
pyridinylmethyl-benzamides (FRAC Group 43) including fluopicolide and fluopimomide;
quinone outside inhibitors, stimatellin binding type (FRAC Group 45) including ametoctradin;
cyanoacrylates (FRAC Groups 47 & 50) including metrafenone, pyriofenone and phenamacril;
polyenes (FRAC Group 48) including natamycin;
oxysterol binding protein homologue inhibitors (FRAC Group 49) including oxathiapiprolin and fluoxapiprolin;
protein fragments (FRAC Group 51) including polypeptide ASFBIOF01-02;
dihydroorotate dehydrogenase inhibitors (FRAC Group 52) including ipflufenoquin and quinofumelin;
FRAC Group 53 including pyridachlometyl;
benzoxaboroles (FRAC Group 54) including tavaborole;
benzo-thiadiazoles (FRAC Group P 01) including acibenzolar-S-methyl;
benzisothiazoles (FRAC Group P 02) including probenazole;
thiadiazole-carboxamides (FRAC Group P 03) including tiadinil and isotianil;
polysaccharides (FRAC Group P 04) including laminarin;
anthraquinone elicitors (FRAC Group P 05) including extracts from Reynoutria sachalinensis;
microbial elicitors (FRAC Group P 06) including Bacillus mycoides isolate J and cell walls of Saccharomyces cerevisiae strain LAS117;
contact pesticides including copper preparations, sulphur, folpet, mancozeb and propineb; and various other fungicides including tecloftalam, triazoxide, flusulfamide, diclomezine, cyflufenamid, dodine, flutianil, ferimzone, tebufloquin, picarbutrazox, validamycin, mineral oils, organic oils, inorganic salts, amobam, ferbam, maneb, metiram, propineb, thiram, zinc thiazole, zineb, ziram, captan, aptafol, folpet, chlorothalonil, dichlofuanid, tolyfluanid, guazatine, iminoctadine, anilazine, dithianon, chinomethionat, fluoroimide, methansulfocarb, extracts from the cotyledons of lupine plantlets, extracts from Swinglea glutinosa, extracts from Melaleuca alternfolia, eugenol, geraniol, thymol, Trichoderma atroviridae strains I-1237, LU132, SC1, SKT-1 and 77B, T asperellum strain T34, T. harzianum strain T-22, T virens strain G-41, Clonostachys rosea strains J1446 and CR-7, Coniothyrium minitans strain CON/M/91-08, Hanseniaspora uvarum strain BC18Y, Talaromyces flavus strain SAY-Y-94-01, Saccharomyces cerevisae strains LAS02 and DDSF623, Bacillus amyloliquefaciens strains QST713, FZB24, MBI600, D747, F727 and AT-332, B. subtilis strains AFS032321, Y1336, HAI-0404 and RTI477, B. velezensis strain RTI301, Erwina spp. peptide PHC25279, Gluconobacter cerinus strain BC18B, Pseudomonas chlororaphis strain AFS009, Streptomyces griseovirides strain K61, S. lydicus strain WYEC108 and cinnamaldehyde.

The one or more cervinomycins of the present invention may exist in formulations of the present invention at a concentration from about 0.0001% to about 99.9999% w/w and any range within this range or any increment within this range.

The one or more additional compounds listed in paragraph [0011] above, may exist in formulations of the present invention at a concentration from about 0.0001% to about 99.9999% w/w and any range within this range or any increment within this range.

The weight and concentration ratio of cervinomycins and the one or more additional compounds may exist in the following synergistic ratios: from about 100,000:1 to about 1:100,000 and any ratio range within this range or any ratio within this range. Synergy between cervinomycins and each of the one more additional compounds is expected as of the filing date of this patent application.

In one embodiment, the present invention is directed to methods of controlling a pest comprising applying an effective amount of a mixture of the present invention to the pest or an area in need of pest control, wherein the pest is a species of the Phylum Oomycota, preferably of the Order Peronosporales or Pythiales, more preferably of the Families Peronosporaceae or Pythiaceae, even more preferably of the Genera Phytophthora, Bremia, Plasmopara, Psuedoperonospora, or Pythium, and most preferably of the species Pseudoperonospora cubensis, Bremia lactucae, Plasmopara viticola, Phytophthora infestans, Phytophthora capsici or Pythium ultimum. In another preferred embodiment, the species of Oomycota may also include Peronospora effusa and Peronospora destructor.

In another embodiment, the present invention is directed to methods of controlling a pest comprising applying an effective amount of a mixture of the present invention to the pest or an area in need of pest control, wherein the pest is a fungus, preferably a species of the Phylum Basidiomycota, preferably of the Class Ustilaginomycetes or Pucciniomycetes more preferably of the Order Ustilaginales or Pucciniales, even more preferably of the Families Ustilaginaceae, Pucciniaceae, or Phakopsoraceae, even more preferably of the Genera Ustilago, Phakopsora, or Puccinia, and most preferably of the species Ustilago maydis, Phakopsora pachyrhizi, or Puccinia triticina, preferably, wherein the one or more cervinomycins are selected from the group consisting of cervinomycin A1 and cervinomycin A2. In another preferred embodiment, the species of Basidiomycota may also include Rhizoctonia solani.

In another embodiment, the present invention is directed to methods of controlling a pest comprising applying an effective amount of a mixture of the present invention to the pest or an area in need of pest control, wherein the pest is a species of the Class Dothideomycetes, more preferably of the Orders Mycosphaerellales, Venturiales or Pleosporales, even more preferably of the Families Mycosphaerellaceae, Venturiaceae or Pleosporaceae, yet even more preferably of the Genera Zymoseptoria, Venturia, Cochliobolus, Pyrenophora, Alternaria or Cercospora and most preferably of the species Zymoseptoria tritici, Venturia carpophila, Cochlobolus miyabeanus, Pyrenophora teres, Alternaria solani, or Cercospora sojina and preferably, wherein the one or more cervinomycins are selected from the group consisting of cervinomycin A1 and cervinomycin A2.

In another embodiment, the present invention is directed to methods of controlling a pest comprising applying an effective amount of a mixture of the present invention to the pest or an area in need of pest control, wherein the pest is a species of the Class Leotimycetes, more preferably of the Order Helotiales, even more preferably the Family Sclerotiniaceae or Ploettnerulaceae and yet even more preferably of the Genus Rhynchosporium or Sclerotinia and most preferably of the species Rhynchosporium secalis or Sclerotinia sclerotiorum and preferably, wherein the one or more cervinomycins are selected from the group consisting of cervinomycin A1 and cervinomycin A2.

In another embodiment, the present invention is directed to methods of controlling a pest comprising applying an effective amount of a mixture of the present invention to the pest or an area in need of pest control, wherein the pest is a species of the Order Magnaporthales, more preferably of the Family Magnaporthaceae, even more preferably of the Genus Magnaporthe and most preferably of the species Magnaporthe oryzae and preferably, wherein the one or more cervinomycins are selected from the group consisting of cervinomycin A1 and cervinomycin A2.

In another embodiment, the present invention is directed to methods of controlling a pest comprising applying an effective amount of a mixture of the present invention to the pest or an area in need of pest control, wherein the pest is a species of the Order Amphisphaeriales, more preferably of the Family Sporocadaceae, even more preferably of the Genus Neopestalotiopsis, preferably, wherein the one or more cervinomycins are selected from the group consisting of cervinomycin A1 and cervinomycin A2.

In another embodiment, the present invention is directed to methods of controlling a pest comprising applying an effective amount of a mixture of the present invention to the pest or an area in need of pest control, wherein the pest is of the Genus Sclerotinia and most preferably of the species Sclerotinia sclerotiorum and preferably, wherein the one or more cervinomycins are selected from the group consisting of cervinomycin A1 and cervinomycin A2.

The one or more cervinomycins of the present invention may be applied at a concentration from about 0.01 to about 10,000 parts per million (“ppm”) and any range within this range or any increment within this range, preferably from about from about 0.01 to about 2,000. Further, the one or more cervinomycins of the present invention may be applied at a concentration from about 0.01 to about 5 ppm, more preferably from about 0.016 to about 5 ppm and even more preferably from about 0. to about 1 ppm and most preferably at about 0.016, 0.063, 0.1, 0.25, 0.5, 0.8, 1, or 5 ppm. Further, the one or more cervinomycins of the present invention may be applied at a concentration from about 0.01 to about 50 ppm, preferably from about 1 to about 60 ppm and even more preferably at about 3, 5, 6, 7.5, 12, 15, 30, 50, 60. Further, the one or more cervinomycins of the present invention may be applied at a concentration from about 50 to about 2000 ppm, preferably at about 200 ppm. Further, the one or more cervinomycins of the present invention may be applied at a concentration from about 120 to about 2,000 ppm, preferably at about 124, 192, 248, 370, 464, 491, 492, 495, 500, 981, 982, 984, 990, 1,000, 1,112, 1,200, 1,376, 1,962, 1,964, 1,968, or 2,000.

The one or more additional compounds listed in paragraph [0011], above, may be applied at a concentration from about 0.01 to about 10,000 ppm and any range within this range or any increment within this range.

As used herein, the term cervinomycin refers to cervinomycins A1-A3, B1-B4, C1-C4 and salts and derivatives thereof. In a preferred embodiment, the one or more cervinomycins of the present invention are selected from the group consisting of cervinomycin A1 and cervinomycin A2.

As used herein, the term cervinomycin A1 refers to a compound listed under the CAS #82658-23-9 and having the following chemical structure:

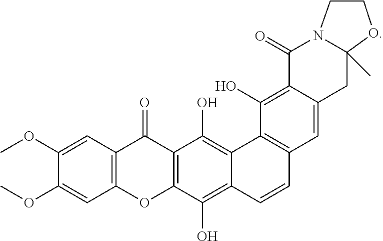 [SMILES: COc1cc2oc3c(O)c4ccc5cc6c(c(O)c5c4c(O)c3c(=O)c2cc1OC)C(=O)N1CCOC1(C)C6]

As used herein, the term cervinomycin A2 refers to a compound listed under the CAS #82658-22-8 and having the following chemical structure.

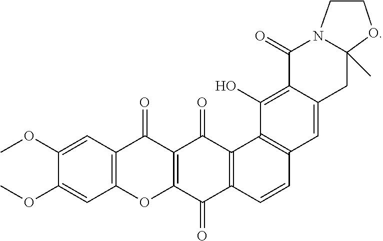 [SMILES: COc1cc2oc3c(c(=O)c2cc1OC)C(=O)c1c(ccc2cc4c(c(O)c12)C(=O)N1CCOC1(C)C4)C3=O]

The species Rhynchosporium secalis is a member of the genus Rhynchosporium of the Family Ploettnerulaceae of the Order Helotiales of the Class Leotiomycetes of the Phylum Ascomycota of the Kingdom Fungi.

The species Botrytis cinerea is a member of the genus Botrytis of the Family Sclerotiniaceae of the Order Helotiales of the Class Leotiomycetes of the Phylum Ascomycota of the Kingdom Fungi.

The species Sclerotinia sclerotiorum is a member of the genus Sclerotinia of the Family Sclerotiniaceae of the Order Helotiales of the Class Leotiomycetes of the Phylum Ascomycota of the Kingdom Fungi.

The species Podosphora xanthii is a member of the genus Podosphora of the Family Erysiphaceae of the Order Erysiphales of the Class Leotiomycetes of the Phylum Ascomycota of the Kingdom Fungi.

The species Erysiphe difusa is a member of the genus Erysiphe of the Family Erysiphaceae of the Order Erysiphales of the Class Leotiomycetes of the Phylum Ascomycota of the Kingdom Fungi.

The Genus Neopestalotiopsis is a member of the Family Sporocadaceae of the Order Amphisphaeriales of the Class Sordariomycetes of the Phylum Ascomycota of the Kingdom Fungi.

The species Magnaporthe oryzae is a member of the genus Magnaporthe of the Family Magnaporthaceae of the Order Magnaporthales of the Class Sordariomycetes of the Phylum Ascomycota of the Kingdom Fungi.

The species Fusarium graminearum is a member of the genus Fusarium of the Family Nectriaceae of the Order Hypocreales of the Class Sordariomycetes of the Phylum Ascomycota of the Kingdom Fungi. Fusarium graminearum is also known as Gibberella zeae.

The species Zymoseptoria tritici is a member of the genus Zymoseptoria of the Family Mycosphaerellaceae of the Order Mycosphaerellales of the Class Dothideomycetes of the Phylum Ascomycota of the Kingdom Fungi.

The species Venturia carpophila is a member of the genus Venturia of the Family Venturiaceae of the Order Venturiales of the Class Dothideomycetes of the Phylum Ascomycota of the Kingdom Fungi. The species Venturia carpophila is also known as Cladosporium carpophilum.

The species Cochliobolus miyabeanus is a member of the genus Cochliobolus of the Family Pleosporaceae of the Order Pleosporales of the Class Dothideomycetes of the Phylum Ascomycota of the Kingdom Fungi. The species Cochliobolus miyabeanus is also known as Bipolaris oryzae.

The species Pyrenophora teres is a member of the genus Pyrenophora of the Family Pleosporaceae of the Order Pleosporales of the Class Dothideomycetes of the Phylum Ascomycota of the Kingdom Fungi.

The species Alternaria solani is a member of the genus Alternaria of the Family Pleosporaceae of the Order Pleosporales of the Class Dothideomycetes of the Phylum Ascomycota of the Kingdom Fungi.

The species Cercospora sojina is a member of the genus Cercospora of the Family Mycosphaerellaceae of the Order Mycosphaerellales of the Class Dothideomycetes of the Phylum Ascomycota of the Kingdom Fungi.

The species Ustilago maydis is a member of the genus Ustilago of the Family Ustilaginaceae of the Order Ustilaginales of the Class Ustilaginomycetes of the Phylum Basidiomycota of the Kingdom Fungi.

The species Phakopsora pachyrhizi is a member of the genus Phakopsora of the Family Phakopsoraceae of the Order Pucciniales of the Class Pucciniomycetes of the Phylum Basidiomycota of the Kingdom Fungi.

The species Puccinia triticina is a member of the genus Puccinia of the Family Pucciniaceae of the Order Pucciniales of the Class Pucciniomycetes of the Phylum Basidiomycota of the Kingdom Fungi.

The species Rhizoctonia solani is a member of the genus Rhizoctonia of the Family Ceratobasidiaceae of the Order Cantharellales of the Class Agaricomycetes of the Phylum Basidiomycota of the Kingdom Fungi.

The species Phytophthora capsici is a member of the genus Phytophthora of the Family Peronosporaceae of the Order Peronosporales of the Phylum Oomycota.

The species Phytophthora infestans is a member of the genus Phytophthora of the Family Peronosporaceae of the Order Peronosporales of the Phylum Oomycota.

The species Pseudoperonospora cubensis is a member of the genus Phytophthora of the Family Peronosporaceae of the Order Peronosporales of the Phylum Oomycota.

The species Bremia lactucae is a member of the genus Phytophthora of the Family Peronosporaceae of the Order Peronosporales of the Phylum Oomycota.

The species Pythium ultimum is a member of the genus Pythium of the Family Pythiaceae of the Order Pythiales of the Phylum Oomycota. Pythium ultimum is also known as Globisporangium ultimum.

The species Plasmopara viticola is a member of the genus Plasmopara of the Family Peronosporaceae of the Order Peronosporales of the Phylum Oomycota.

The species Peronospora effusa is a member of the genus Peronospora of the Family Peronosporaceae of the Order Peronosporales of the Phylum Oomycota. Peronospora effusa is also known as Peronospora farinose f. sp. spinaciae.

The species Peronospora destructor is a member of the genus Peronospora of the Family Peronosporaceae of the Order Peronosporales of the Phylum Oomycota.

In another embodiment, the present invention is directed to a method of controlling a pest comprising applying a composition comprising a mixture of the present invention.

In another embodiment, the present invention is directed to compositions for pest control comprising a mixture of the present invention and one or more excipients.

In a preferred embodiment, compositions of the present invention may be directed to control any of the specific species or phylogenetic clades disclosed in this specification.

In a preferred embodiment, the compositions of the present invention may further comprise one or more excipients selected from the group consisting of solvents, anti-caking agents, stabilizers, defoamers, slip agents, humectants, dispersants, wetting agents, thickening agents, emulsifiers, penetrants, adjuvants, synergists, polymers, propellants and preservatives.

The compounds of the present invention can be applied by any convenient means. Those skilled in the art are familiar with the modes of application including but not limited to, spraying, brushing, soaking, granule application, pressurized liquids (aerosols), and fogging. Spraying includes space sprays. Space sprays include aerosols and thermal fog spray. Other modes of application familiar to those in the art include soil applications including spraying, drenching, drip lines, in-furrow treatments, or side-dressing and seed applications.

As used herein, “to control” a pest or “controlling” pest(s) refers to killing, inhibiting, incapacitating, repelling, or otherwise decreasing the negative impact of the pest on plants or animals to a level that is desirable to the grower, applicator or user.

As used herein, “an area in need of pest control” refers to any area that the pest is present during any life stage. One environment likely to be treated by the methods of the present invention includes the plants that the pest is living on and/or the surrounding soil. The pest's environment may also include an area where plants are grown, harvested, or in gardens, fields, greenhouses, or other buildings, and various indoor surfaces and structures, such as furniture including beds, and furnishings including books, clothing, etc.

As used herein, all numerical values relating to amounts, weight percentages and the like are defined as “about” or “approximately” each particular value, namely, plus or minus 10%. For example, the phrase “about 5,000 parts per million” is to be understood as “from 4,500 to 5,500 parts per million.” Therefore, amounts within 10% of the claimed values are encompassed by the scope of the claims.

As used herein, “composition” refers to one or more active ingredients in a carrier. The carrier may be a liquid, a semi-solid, a solid or a gas and may contain additional ingredients.

The term “effective amount” means the amount of the cervinomycin that will control the target pest. The “effective amount” will vary depending on the cervinomycin concentration, the type of pest(s) being treated, the severity of the pest infestation, the result desired, and the life stage of the pest during treatment, among other factors. Thus, it is not always possible to specify an exact “effective amount.” However, an appropriate “effective amount” in any individual case may be determined by one of ordinary skill in the art.

The articles “a,” “an” and “the” are intended to include the plural as well as the singular, unless the context clearly indicates otherwise. For example, the methods of the present invention are directed to controlling “pest”, but this can include control of a multiple pests (such as a more than one insect or more than one insect species or more than one mite or more than one mite species).

The disclosed embodiments are simply embodiments of the inventive concepts disclosed herein and should not be considered as limiting unless the claims expressly state otherwise.

The following examples are intended to illustrate the present invention and to teach one of ordinary skill in the art how to use the formulations of the invention. They are not intended to be limiting in any way.

### EXAMPLES

### Example 1. Controlling Particular Fungi with Cervinomycins In Vitro

### Method

Biological efficacy assays utilizing cervinomycins were conducted on Plasmospora viticola. Groups of grape plants were infected with P. viticola and treated with either 13, 50, 200 or 800 ppm of cervinomycin A1 or A2 or a killed TGAI containing 33.2% cervinomycin A1 and 66.7% cervinomycin A2. Treatments occurred at either 1 day before infection (“1 DBI”), 7 days before infection (“7 DBI”) or 1 day after infection (“1 DAI”). Percent control was based on the reduction of growth of a given pathogen on non-cervinomycin amended growth media in comparison to the growth observed on growth media amended with cervinomycin A1 and/or A2. Results can be found in Table 1, below.

TABLE 1

| | Dose | Plasmospora viticola | | |
|---|---|---|---|---|
| % control | (ppm) | 1DAI | 1DB1 | 7DBI |
| Cervinomycin | 13 | 0 | 100 | 80 |
| A1 | 50 | 0 | 100 | 99 |
| | 200 | 0 | 100 | 100 |
| | 800 | 7 | 100 | 100 |
| Cervinomycin | 13 | 0 | 96 | 61 |
| A2 | 50 | 3 | 100 | 91 |
| | 200 | 0 | 100 | 97 |
| | 800 | 5 | 100 | 100 |
| Killed TGAI* | 13 | 0 | 83 | 31 |
| | 50 | 3 | 96 | 87 |
| | 200 | 0 | 100 | 94 |
| | 800 | 0 | 100 | 100 |

*33.7% cervinomycin A1 and 66.3% cervinomycin A2

As seen in Table 1, above, treatment with 13-800 ppm cervinomycin A1 or A2 or a mixture thereof provided significant control of P. viticiola. This result is unexpected as there was no previous indication that cervinomycins would control P. viticiola.

What is claimed is:

1. A pesticidal mixture comprising one or more cervinomycins and at least one additional compound listed in paragraph [0011] of the instant specification.

2. A method of controlling a pest comprising applying the mixture of claim 1 to the pest or an area in need of pest control, wherein the pest is a species of the Phylum Oomycota.

3. The method of claim 2, wherein the one or more cervinomycins is selected from cervinomycin A1 and cervinomycin A2.

4. A method of controlling a pest comprising applying an effective amount of the mixture of claim 1 to the pest or an area in need of pest control, wherein the pest is a species of fungus.

5. A method of controlling a pest comprising applying an effective amount of the mixture of claim 1 to the pest or an area in need of pest control, wherein the pest is a species of the Phylum Basidiomycota.

6. The method of claim 5, wherein the pest is a species of the Class Ustilaginomycetes or Pucciniomycetes.

7. The method of claim 6, wherein the pest is selected from the group consisting of Ustilago maydis, Phakopsora pachyrhizi, or Puccinia triticina.

8. The method of claim 5, wherein the one or more cervinomycins is selected from cervinomycin A1 and cervinomycin A2.

9. A method of controlling a pest comprising applying an effective amount of the mixture of claim 1 to the pest or an area in need of pest control, wherein the pest is a species of the Class Dothideomycetes.

10. The method of claim 9, wherein the pest is a species of an Order selected from a group consisting of Mycosphaerellales, Venturiales or Pleosporales.

11. The method of claim 10, wherein the pest is selected from the group consisting of Zymoseptoria tritici, Venturia carpophila, Cochlobolus miyabeanus, Pyrenophora teres, Alternaria solani, and Cercospora sojina.

12. The method of claim 9, wherein the one or more cervinomycins is selected from cervinomycin A1 and cervinomycin A2.

13. A method of controlling a pest comprising applying an effective amount of the mixture of claim 1 to the pest or an area in need of pest control, wherein the pest is a species of the Class Leotiomycetes.

14. The method of claim 13, wherein the pest is a species of the Family Ploettnerulaceae or Sclerotiniaceae.

15. The method of claim 14, wherein the pest is Rhynchosporium secalis or Sclerotinia sclerotiorum.

16. The method of claim 13, wherein the one or more cervinomycins is selected from cervinomycin A1 and cervinomycin A2.

17. A method of controlling a pest comprising applying an effective amount of the mixture of claim 1 to the pest or an area in need of pest control, wherein the pest is a species of the Order Magnaporthales.

18. The method of claim 17, wherein the pest is of the species Magnaporthe oryzae.

19. A method of controlling a pest comprising applying an effective amount of the mixture of claim 1 to the pest or an area in need of pest control, wherein the pest is a species of the Order Amphisphaeriales.

20. The method of claim 19, wherein the pest is a species of the Genus Neopestalotiopsis.
